(19) United States
(12) Patent Application Publication
(10) Pub. No.: US 2006/0168467 A1
(43) Pub. Date: Jul. 27, 2006

(54) Load testing methods and systems with transaction variability and consistency

(76) Inventors: Russell L Couturier, Loveland, CO (US); Joseph A.L. Marino, Belchertown, MA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/531,221

(22) PCT Filed: Oct. 16, 2003
(86) PCT No.: PCT/US03/32724

§ 371 Date: Oct. 28, 2005

Related U.S. Application Data
(60) Provisional application No. 60/418,824, filed on Oct. 16, 2002.

(51) Int. Cl. G06F 11/00

(52) U.S. Cl. 714/4

(57) ABSTRACT

Disclosed are load testing methods and systems with transaction variability and consistency.

### CROSS REFERENCE TO RELATED APPLICATIONS

This nonprovisional patent application is based upon and claims priority from U.S. provisional patent application Ser. No. 60/418,824, filed Oct. 16, 2002, entitled “Load Testing Methods And Systems With Transaction Variability And Consistency.”

This nonprovisional patent application is related to commonly-owned, co-pending U.S. nonprovisional patent application Ser. No. 10/210,798 filed Aug. 1, 2002, entitled “Protocol Sleuthing System And Method For Load-Testing A Network Server,” set forth in pertinent part below.

### FIELD OF THE INVENTION

The present invention is directed generally to network load testing methods and systems. More particularly, the present invention relates to methods and systems capable of generating uniquely variable transaction instances within a set of defined testing populations, thereby providing transaction variability and consistency, and thus, realistic test loads.

### BACKGROUND OF THE INVENTION

The rapidly expanding use of computer networks and application services provided by network servers in today's society has led to an increased need to test, monitor, and evaluate the load capacity of such network servers, particularly in the context of providing application services requested by users.

Client/Server Transactions: In the past, effective load testing of networks and associated application services required a multiplicity of actual users simultaneously generating continuous transactions with the various applications available through a particular network server. The load represented by these transactions enables network designers, administrators, and operators to analyze the network and application services under stress.

It is impractical, however, to conduct realistic network load testing using conventional methods. Consider, for example, the hardware and software resources required by a single, actual user in conducting conventional client/server transactions with a network server, as illustrated in FIGS. 1 and 2.

As shown in FIG. 1, the user employs a web browser or similar client application CA running on personal computer PC (or other processor), and an associated graphical user interface GUI, to conduct the client/server transactions with server application SA on the network server computer NSC. The user also employs the PC's associated hardware, including a keyboard, monitor, and modem or other communications devices, to enter URL addresses for network resources and content.

Similarly, FIG. 2 illustrates a typical client-server transaction (surfing for information on the Internet), using the resources illustrated in FIG. 1. The user employs the browser or similar client application CA to request HTML (Hypertext Markup Language) pages from the server application SA on the network server computer NSC. The client/server transactions consist of a series of defined protocol interactions between the browser CA and the server application SA. These can include client requests and server responses in accordance with a standard protocol such as FTP (File Transfer Protocol). For example, as shown in FIG. 2, the user initiates the protocol interactions defined for this particular client-server transaction by request CR1 to connect to the network server computer NSC. The user may do this in the conventional manner by typing a URL address “xyz” of the network server computer NSC or clicking on a link. The network server computer NSC then issues a response SR1, granting or denying the client request. Once connected to the network server computer NSC, the client requests that the server application SA be opened on a specific port number “abc” (request CR2), and the server NSC responds (SR2) by granting the request. Next, the client requests a file, www.mysite.com/myfile.html (request CR3), and the server NSC responds by transmitting the requested file to the client computer PC. Following client requests CR4 and CR5, and the server's responses SR4, SR5, the client-server transaction is voluntarily terminated by the user.

It will be readily understood that such client/server transactions are resource intensive. A browser's GUI and display engines require extensive memory and CPU resources to support the processing and transmission of application requests and the display of content provided by the server. A single web browser, for example, can utilize as much as 10 Megabytes of memory during a single client/server transaction.

Conventional Load Testing: In some systems, network load testing is accomplished using the client resources and transaction format described above, in combination with utility macros that record the user's interactions with the client and server applications. These macros can record all user input (keystrokes, mouse movements and clicks) and relevant responses from the server application during the transaction, and the recorded information can be replayed for review and evaluation. However, because the user's interactions with the client and server applications are predominately graphical, detecting and isolating errors is time consuming and labor intensive. Since GUIs do not typically include elements for automatically detecting error events, it is left to the user to detect errors visually.

In addition, scaling a conventional load testing method to provide statistically useful load testing data requires generating a large number of simulated users. In turn, each simulated user requires the entire client application, including the GUI. Thus, simulating one hundred web users would require the client computer to create one hundred instances of the client application and the network server application. The associated memory and processing requirements could easily overwhelm a typical client computer.

Accordingly, there is a significant need for methods and systems that can generate a vast number of transactions, to simulate real user loads, without a concomitantly large resource requirement.

It would also be desirable to provide load testing methods and systems capable of creating traffic that accurately simulates a real user load. In conventional load testing systems, designers attempt to mimic real traffic by creating multiple populations of (synthetic) users with defined characteristics. For example, a single user's web browsing behavior might be defined by the following:

Listing 1:

1. Access web server at IP address xxx. xxx. xxx. xxx.

2. Login as user XYZ with password JKL.

3. Retrieve web page mywebpage.html

4. Wait 15 seconds.

5. Repeat this transaction.

Given this description, a test administrator could create a test by generating a population of thousands of instances of this specific user behavior, thereby creating the user load. However, each instance would have exactly the same attributes. The resulting population of identical instances would not create a realistic user load, since real users do not all log into the same server, access the same web page, wait exactly 15 seconds and then repeat.

In addition, typical infrastructure, including network devices, HTTP servers, and storage systems, would cache the data, resulting in minimal network traffic, minimal data storage access, and minimal HTTP server activity, thus yielding invalid results. A test of this nature would falsely indicate that the network could service thousands more users than it actually could under a real load.

The test administrator could create multiple populations, each having different characteristics. However, this would only be truly representative of a unique user load if a population were created for every instance generated. Under such circumstances, it could take the test administrator weeks to construct a simple test.

Accordingly, there is a significant need for the ability to easily generate unique instances of multiple user population classes that represent real loads.

### SUMMARY OF THE INVENTION

In one aspect, the invention provides a network load testing system comprising: an addressable named list means to enable the generation of substantially random and unique network transaction instances simulative of real network traffic patterns; addressing means operable to address the named list means; and generating means, operable to communicate with the addressing means, for generating the substantially random and unique network transaction instances simulative of real network traffic patterns.

### BRIEF DESCRIPTION OF DRAWING FIGURES

FIG. 1 is a block diagram showing a conventional client/server transaction.

FIG. 2 is a diagram outlining protocol aspects of the transaction of FIG. 1.

FIG. 3 is a schematic diagram illustrating one practice of the present invention.

FIG. 4 is a schematic diagram showing the use of Named List structures.

FIG. 5 is a schematic diagram showing a test in accordance with the invention.

FIG. 6 is a schematic diagram showing a test plan.

FIG. 7 is a schematic diagram showing an exemplary “screen shot” of runtime attributes.

FIG. 8 illustrates an error event occurring during the client-server transaction illustrated in FIG. 2.

FIG. 9 illustrates a protocol sleuthing system.

FIG. 10 is an illustrative example of the implementation of a ‘background client’ consisting of four ‘synthetic users’ interacting with an application available through a network server.

FIG. 11 illustrates the differences between a client-server transaction conducted by a human and a client-server transaction implemented by a background client via a protocol sleuthing system and method.

### DETAILED DESCRIPTION OF THE INVENTION

I. Synthetic Transaction Variability: The present invention generates uniquely variable transaction instances within a set of defined testing populations, thereby providing transaction variability and consistency, and thus, realistic test loads. In one aspect of the invention, synthetic transaction instances, simulative of the network load presented by real users, are generated in accordance with a test plan containing multiple population classes or “groups.” Each group contains attributes that describe the behavior of each instance generated within the group. Based on the test plan and the attributes of groups therein, the system generates a number of instances and an appropriate network protocol (collectively, the load) for the test. These latter functions are implemented by a Network Testing Resource (NTR) application.

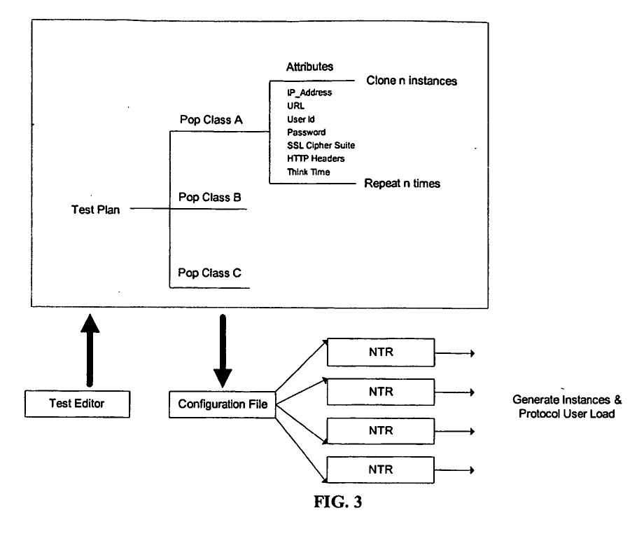

FIG. 3 illustrates one practice of the present invention, including a test plan with three groups, referred to therein as Population Classes A, B and C.

Referring to FIG. 3, it will be seen that the system generates, for Population Class A, web browser traffic having the attributes shown on the right-hand side of FIG. 3. In turn, Population Class B could be an FTP (File Transfer Protocol) session with similar attributes, and Class C could represent a streaming video population.

In another aspect of the invention, described in greater detail below, this information is created by a test editor application, and stored in a configuration file that can be “pushed” to the NTRs, which then generate the instances and protocols that constitute the load.

In accordance with FIG. 3 (and using the parameters noted above in the prior art example), the attributes may have the following static settings:

Listing 2:

1. IP address=192.168.3.23

2. URL=www.mywebsite.html

3. Userid=John

4. Password=que123

5. SSL Cipher Suite=EXPORT40

6. HTTP Header=German

7. Think time=15

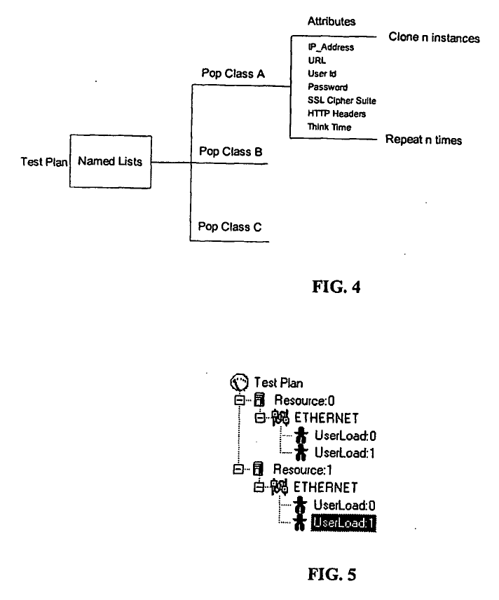

The present invention enables a characteristic referred to herein as Synthetic Transaction Variability (STV), in which each instance associated with a user class population has unique attributes. This uniqueness, in turn, enables the realistic simulation of actual user loads. One way in which STV is accomplished is through the use of Named List structures, as shown schematically in FIG. 4.

Referring now to FIG. 4, there is shown a test plan containing a named list structure. In one practice of the invention, each test plan has the ability to create and store multiple named lists. The named lists are created as part of the test plan, and each named list may consist of URLs, language headers, IP addresses, cipher suites, or any group attribute that, in the prior art, previously required a static value. In the illustrated embodiment, a named list is common to all population classes and may be reusable among classes. Each list has a name and an unlimited number of members.

Assume, for example, that a test plan has two lists, one that contains HTTP language headers and another that contains URLs. The first list (Listing 3) is named $listofHTTPHeaders and contains (by way of example) a list of language headers. The second list (Listing 4) is named $listofURLs, and lists candidate URLs, as follows:

Listing 3:

1. German

2. English

3. French

4. Italian

5. Ukrainian

6. etc.

Listing 4:

1. /mywebsite/page1.html

2. /mywebsite/page2.html

3. /mywebsite/page3.html

4. /mywebsite/page4.html

5. /mywebsite/page5.html

6. etc.

Given these list structures, instead of being limited (as was the prior art) to having static attributes that define a population class, the load testing system of the present invention can utilize the lists to provide Synthetic Transaction Variability. By way of example, the system can employ functions that provide random (@lrand) and sequential (@lnext) access to the lists, defined as follows:

@Irand($list)

This function returns a random member of ($list) between 1 and lengthoflist.

@lnext($list)

This function returns the next member of the list ($list). Once the end of the list is reached, the list pointer rewinds to the beginning.

To see how this affects the resulting instances, consider the following Listing 5, showing Listing 2 with STV introduced:

Listing 5:

1. IP address=192.168.3.23

2. URL=@lrand($listofURLs)

3. Userid=John

4. Password=que123

5. SSL Cipher Suite=EXPORT40

6. HTTP Header=@lnext($listofHTTPHeaders)

7. Think time=15

8. Repeat.

Assume that 1000 instances are created for the population class A, in accordance with Listing 5. Given lines 2 and 6 of Listing 5, each instance would get a unique value for URL and HTTP Header. These attributes would also vary for each repeat of the loop, thus creating random and realistic user loads.

In the above example (Listing 5), any of the static attributes could point to a list. In this example, a random member from $listofURLs will be retrieved each time the instance is repeated; and for each iteration, the next member of the list $listofHTTPHeaders will used to generate requests from different languages. The list pointer will rewind when it reaches the end of the list.

Synthetic Transaction Consistency: The present invention also enables another useful property: Synthetic Transaction Consistency or STC. In accordance with the invention, STC enables each instance of a user class population to have uniquely predictable runtime attributes. This is advantageous for designing tests that require authentication or known parameters within a defined range, with repeatable results.

Consider, for example, a website that requires users to authenticate prior to downloading data. Generating thousands of instances of a user class would result in the same authentication for each instance, thereby resulting in an improbable scenario. Another example would be a user class that sends email to another account. Thousands of instances that generate mail sent to one user would not represent real traffic.

Accordingly, the present invention enables synthetic transaction consistency by using runtime variables to generate unique and consistent attributes for instances of a group. These runtime attributes can be based upon the following objects used within a test plan:

Test Plan

Resources

Interfaces

Groups

Group Instances

In particular, as schematically shown in FIG. 5, a test consists of a test plan that contains multiple resources, each with one or more interfaces that contain one or more groups.

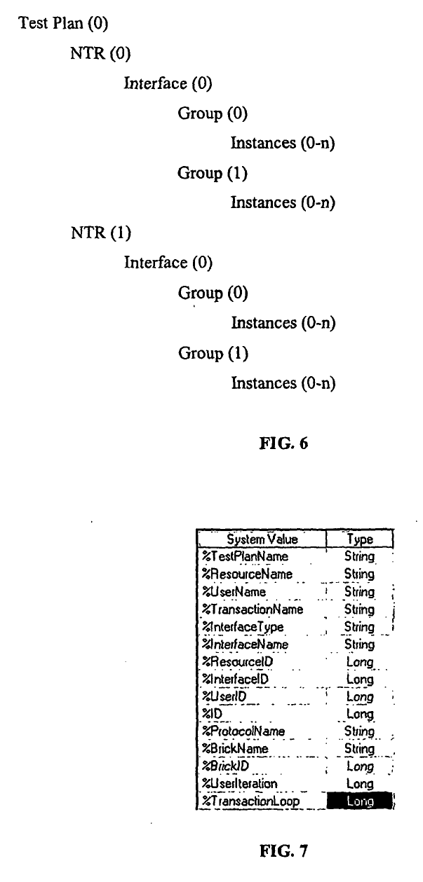

The test plan shown in FIG. 5 contains two resources, each with one (Ethernet) interface that contains two user groups (userload:0 and userload:1). Thousands of instances can be generated for each group. In turn, each object has an internal name and numerical value. For example, each resource can be assigned a unique integer 1 through n, where n is the last resource. This is true for each object in the plan. The test plan can then be represented as shown in FIG. 6.

Runtime Attributes: In one practice of the invention, the system provides runtime access to the names and integer values of each test object. FIG. 7 is an exemplary “screen shot” of the runtime attributes.

The screen shot of FIG. 7 contains a “System Value” on the left, and “Type” on the right. System values in the illustrated example include TestPlanName, ResourceName, UserName, TransactionName, InterfaceName, ResourceID, InterfaceID, UserID, ID, ProtocoIName, BrickName, BrickID, UserIteration, and TransactionLoop. Types can be Long or String. The runtime attributes can be combined using a string function to derive values for brick attributes. For example, the following function creates a unique user id for each unique instance within a test plan:

userid=@string(“user”, % resourceid, % interfaceid, % userid, % id)

Using this function, the first instance of the first group of the first interface of the first NTR would resolve to “user0000”. The next instance would be “user0001” and so forth. The first instance of the first group of the first interface of the second NTR would resolve to “user1000”. This allows a test plan developer to create thousands of unique attributes with just a “clicks” of a mouse.

II. Protocol Sleuthing: The following discussion sets forth examples of protocol sleuthing for load-testing in which the above described methods and systems can be implemented. The following discussion is directed to a protocol sleuthing system and method for creating and implementing a plurality of synthetic users, each synthetic user implementing a plurality of synthetic transactions for cost and resource-effective load testing of a network server and the associated application services provided thereby. The protocol sleuthing system is concomitantly operative to monitor each synthetic transaction and to detect and report any error events occurring during any synthetic transaction.

Concomitant with the wide spread use of computer networks and application services provided by network servers in today's society is the need to test, monitor, and evaluate the load capacity of such network servers, particularly in the context of providing application services requested by users.

Effective load testing of today's networks and associated application services requires a multiplicity of actual users simultaneously generating continuous transactions with any particular application available through a particular network server. It is, however, economically impracticable, both from a resource standpoint and a time standpoint, to conduct network load testing in such a manner.

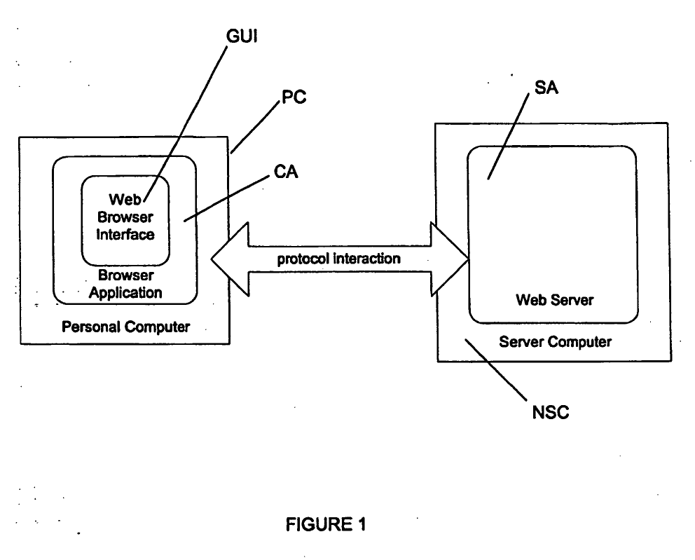

Consider, for example, the resources required by an actual user in conducting one or more client-server transactions with a network server. FIG. 1 illustrates the hardware and application resources required for such client-server transactions. An actual user requires a computer PC that includes hardware for inputting requests, e.g., a keyboard for typing in the URL address of the network application to be accessed, hardware for displaying content, e.g., a monitor, and hardware for providing a communications interface with a network server computer NSC, e.g., a modem. A client application CA that includes a graphical user interface (GUI) with its associated drop-down menus and toolbars, e.g., a WEB browser such as Netscape Navigator, Microsoft Internet Explorer, or Opera, is stored on the personal computer PC and provides the necessary functionality for the user to conduct client-server transactions with a server application SA available from the network server computer NSC.

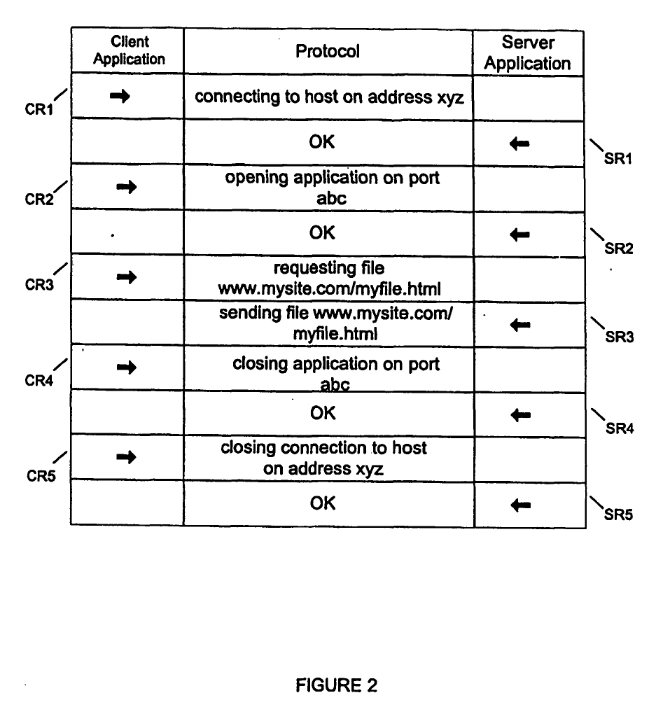

FIG. 2 illustrates a typical client-server transaction, using the resources illustrated in FIG. 1, wherein the actual user utilizes the client application CA, e.g., browser, stored on the computer PC to request HTML pages/files from the server application SA on a network server computer NSC, i.e., the actual user is surfing for information on the Internet. This client-server transaction consists of a series of defined protocol interactions between the browser (client application) and the server application, i.e., client requests and server responses to such client requests, in accordance with a standard protocol such as FTP (File Transfer Protocol). For example, referring to FIG. 2, the actual user initiates the protocol interactions defined for this particular client-server transaction by means of a request CR1 to connect to the network server computer NSC (by inputting the URL address “xyz” of the network server computer NSC via the client graphical user interface GUI, e.g., by keyboard inputs or clicking on a link). The network server computer NSC issues a response SR1 granting or denying this client request. Once connected to the network server computer NSC, the client requests that the server application SA be opened on a specific port number, e.g., “abc” (request CR2), and the server NSC responds by granting this request, i.e., response SR2. Next, the client requests a specific file, e.g., “www.mysite.com/myfile.html” by means of request CR3, and the server NSC responds by transmitting the requested file to the client computer PC. By means of client requests CR4 and CR5, and the server's responses thereto, i.e., responses SR4, SR5), the client-server transaction is voluntarily terminated by the user.

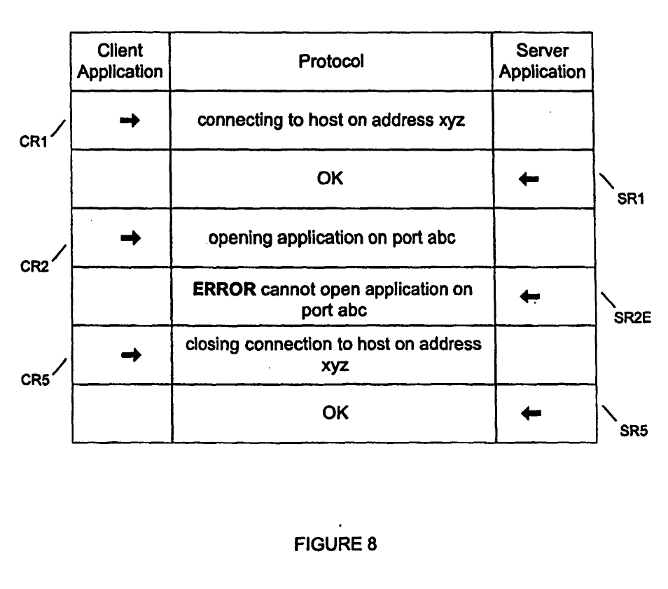

At any point in these protocol interactions, however, the server NSC can respond to any particular client request by means of an error message, i.e., the server denies a particular client request. Such a denial of a client request may be predicated on any number of diverse events, e.g., an authentication failure (initial request to establish a client-server relationship), a temporary lack of a server resource, e.g., CPU processing, memory, necessary to fulfill the client request, or a server application processing error. By way of example, refer to FIG. 8 which illustrates an error event occurring during a client-server transaction of the type illustrated in FIG. 2. In this particular client-server transaction, the server NSC issues an error message, i.e., server response SR2E, in response to the client request CR2. A denial of a client request causes the client application CA to automatically terminate the protocol interactions, i.e., the client-server transaction, as illustrated by client request CR5 and the corresponding server response SR5 in FIG. 8. A premature termination of client-server transaction due to a denial of a client request/error message from the server NSC (or the lack of a response from the server NSC to a valid client request) is defined as an “error event”.

Client-server transactions such as the foregoing are resource intensive, the graphical interface and display engines of a browser client application consuming extensive memory and CPU processing resources to support the graphical user interface, processing and transmission of application requests, and the display of content provided by the server. A single web browser, for example, can utilize as much as 10 Megabytes of memory during a single client-server transaction.

Network load testing is currently accomplished using the client resources and client-server transaction format described in the preceding paragraphs in conjunction with utility macros that record the user's interactions with the client and server applications, e.g., these macros record all user input (keystrokes, mouse movements and clicks) and relevant responses from the server application during the client-server transaction. These recorded macros are subsequently replayed to review and evaluate the information recorded by these macros. Because the user's interactions with the client and server applications are predominately graphical, detecting and isolating errors is time consuming and labor intensive. Since application graphical user interfaces do not typically include any means or mechanism for detecting error events, the detection of error events is a visual process.

To scale the foregoing load-testing scheme to provide valid load-testing data requires a large number of simulated users to generate statistically-sufficient data. However, each such simulated user for the foregoing load-testing would require the entire client application, including the graphical user interface. Accordingly, to simulate 100 web users in accordance with this load-testing scheme would require the client computer to instantiate 100 instances of the client application and the network server application, which would typically overwhelm the memory resources of the client computer. Therefore, because of excessive resource requirements, the foregoing load-scheme is not scalable to the extent necessary to generate statistically-valid data for network load testing.

A need exists to provide a means for load-testing network servers and the associated application services provided thereby that is not resource intensive. Such a means should be capable of being implemented using a single computer system. Such means should concomitantly enable monitoring, detecting, and reporting of error events detected during network load-testing

Accordingly, a protocol sleuthing system described herein creates a plurality of synthetic users wherein each of the synthetic users generates a plurality of synthetic transactions in accordance with a specified protocol for load testing of a network server.

Also provided is a means for monitoring each of the plurality of synthetic transactions generated by each of the plurality of synthetic users to detect any error events occurring during any of such synthetic transactions and reporting any error events detected during any of such synthetic transactions.

In a further aspect, a protocol sleuthing system can load test a network server that includes a computer configured to interconnect with the network server, a protocol engine stored in and implemented by the computer and operative to generate a plurality of synthetic users, to generate a synthetic transaction in accordance with a specified protocol, and to cause each of the plurality of synthetic users to sequentially implement a plurality of the synthetic transactions with the network server for load testing thereof, a configuration file connected to the protocol engine that includes variables required to generate the synthetic transaction, information that defines the behavior of the plurality of synthetic users implementing the synthetic transaction, and information that defines the number of synthetic users to be created by the protocol engine, and a module that is operative to monitor each of the plurality of synthetic transactions implemented by each of the plurality of synthetic users with the network server, to detect any error event occurring during any of the plurality of synthetic transactions implemented by any of the plurality of synthetic users, and to report any error event detected during such network testing.

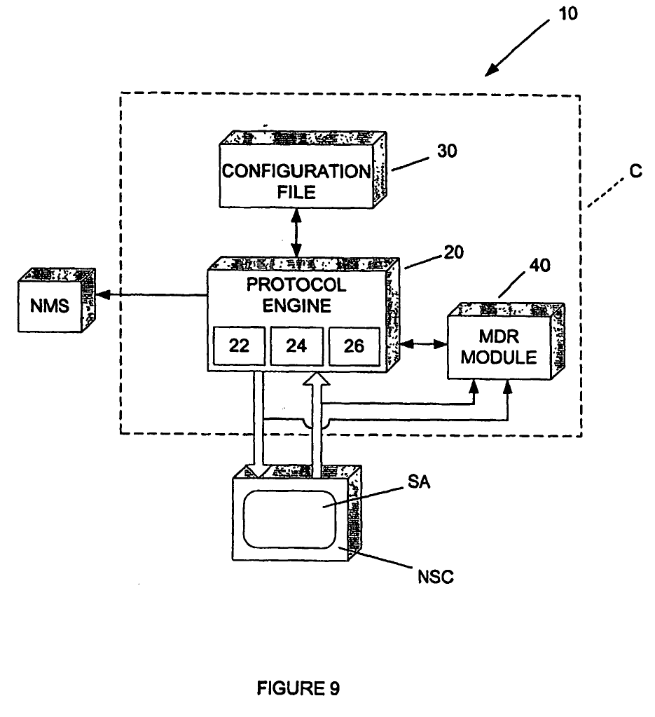

FIG. 9 illustrates one embodiment of a system 10 for protocol sleuthing. The protocol sleuthing system 10 comprises a plurality of interactive components that provide the functionality necessary to create a plurality of ‘synthetic users’, to establish a client-server relationship and generate a sequential plurality of ‘synthetic transactions’ with a network server NSC for each ‘synthetic user’, and to monitor each ‘synthetic transaction’ for the purpose of detecting and reporting any error event occurring during each such ‘synthetic transaction’. The protocol sleuthing system 10 effectively provides a windowless background client that does not require any type of user interface to generate ‘synthetic transactions’ with a network server, i.e., the system 10 is not resource intensive. The protocol sleuthing system 10 provides the capability to create and implement a large number of ‘synthetic users’ on a single computer system, thereby providing the necessary scalability to ensure statistically-significant load testing of network servers and their associated application services.

The protocol sleuthing system 10 has utility for network load testing based upon client-server transactions in accordance with a standard protocol such as HTTP (Hypertext Transfer Protocol), FTP (File Transfer Protocol), SMTP (Simple Mail Transfer Protocol), POP3 (Post Office Protocol 3), IMAP (Internet Message Access Protocol), and NNTP (Network News Transfer Protocol). In addition to client-server transactions using a standard protocol, the protocol sleuthing system 10 also has utility in client-server transactions using a defined protocol (“defined” being used in the context that the protocol is documented, but not universally or generally used/accepted, e.g., a proprietary protocol used by an enterprise in intranet or extranet transactions—contrast with ‘standard’ which indicates a protocol established by general consent (or authority) as a general model or example that is universally or generally used/accepted).

The protocol sleuthing system is implemented by means of a computer C and comprises a protocol engine 20, a configuration file 30, and a monitoring, detecting, and reporting (MDR) module 40.

The protocol engine 20, which can be stored in and implemented by a single computer C, is operative to generate a plurality of ‘synthetic users’, and is further operative to cause each ‘synthetic user’ to generate multiple, sequential ‘synthetic transactions’ with the network server NSC in accordance with a specified protocol. Concomitantly, the protocol engine 20 is also operative to implement the MDR module 40 to continuously monitor each ‘synthetic transaction’ and to detect and report any error event occurring during any ‘synthetic transaction’. The protocol engine 20 includes a first set of instructions 22, a second set of instructions 24, and a set of control instructions 26.

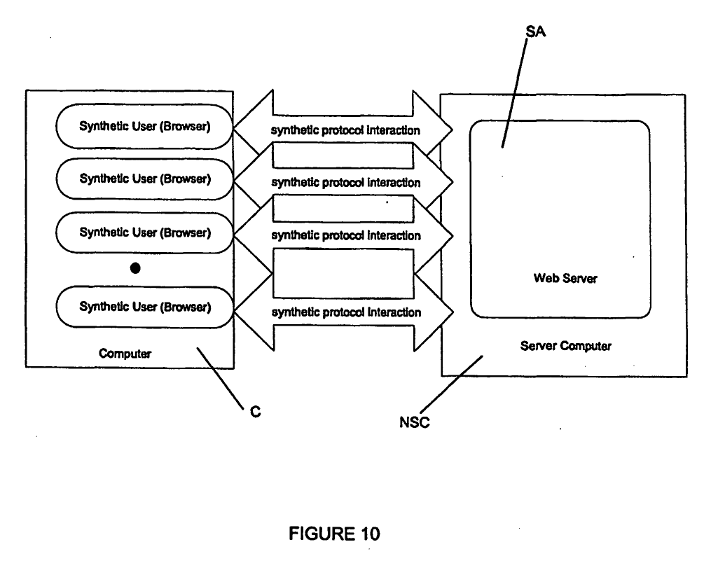

The first set of instructions 22 executed by the protocol engine 20 establishes a client-server relationship with the network server NSC in accordance with a specified protocol. For example, where the ‘synthetic transaction’ is a file transfer request to the network server NSC in accordance with the File Transfer Protocol, the first set of instructions 22 executed by the protocol engine 20 implement the client requests CR1, CR2 exemplarily illustrated in FIG. 2 to establish a client-server relationship between the computer C and the network server NSC (see also FIG. 1). The protocol engine 20 is also operative to execute the first set of instructions 22 to terminate the client-server relationship, for example, at the successful conclusion of a ‘synthetic transaction’, as exemplarily illustrated by the client requests CR4, CR5 in FIG. 10. Or, as illustrated in FIG. 8, the protocol engine 20 is operative to execute the first set of instructions to terminate the client-server relationship upon the detection of an error event during the establishment of the client-server relationship, as exemplarily illustrated by the client request CR5 in FIG. 8.

The first set of instructions 22 can also include a subset of instructions for retrieving any variable(s) from the configuration file 30 necessary to establish the client-server relationship between the computer C and the network server NSC in accordance with a specified protocol. Most typically, such variables would include a user or login name and a password where the specified protocol requires an “authentication login protocol” as a prelude to establishing a client-server relationship. A representative instruction where the establishment of the client-server relationship requires an authentication login protocol is ftpget(username, password) where the parameters username and password are variables stored in the configuration file 30 (see discussion below regarding the configuration file 30).

One skilled in the art will appreciate that the specifics regarding the first set of instructions 22 executed by the protocol engine 20 depend upon the protocol required for the implementation of a particular ‘synthetic transaction’. One skilled in the art will be able to generate the first set of instructions 22 necessary to establish a client-server relationship with any network server in accordance with a specified protocol without undue experimentation.

The second set of instructions 24 executed by the protocol engine 20 accomplishes the task or tasks defined by the ‘synthetic transaction’ in accordance with the specified protocol. For example, where the ‘synthetic transaction’ is a file transfer request to the network server NSC in accordance with the File Transfer Protocol, the second set of instructions 24 executed by the protocol engine 20 accomplish the task of transferring a particular file from the network server NSC to the computer C. To accomplish this task, the second set of instructions 24 would implement the client request CR3 exemplarily illustrated in FIG. 2 to request that the network server NSC transfer a copy of the particular file, e.g., “myfile”, to the computer C.

Where the network server NSC transfers the requested content, e.g., “myfile”, to the computer C as part of the ‘synthetic transaction’, the second set of instructions 24 executed by the protocol engine 20 are further operative to ensure that such transferred content does not encumber the memory resources of the computer C. For example, the second set of instructions 24 can be designed to immediately delete such transferred content or may be designed to direct such transferred content to the recycle bin of the computer C.

In accomplishing any particular task or tasks defined by the ‘synthetic transaction’ in accordance with the specified protocol, the protocol engine 20 may require one or more variables in carrying out the task or tasks defined by the ‘synthetic transaction’. The second set of instructions 24, therefore, includes a subset of instructions for retrieving any variables necessary in accomplishing such task or tasks comprising the ‘synthetic transaction’ from the configuration file 30. For example, where the ‘synthetic transaction’ is a file transfer request to the network server NSC in accordance with the File Transfer Protocol to retrieve a particular file as exemplarily illustrated in FIG. 2, this subset of instructions would be operative to retrieve variables identifying the directory where the particular file is stored, the filename of the particular file, and the filetype of the particular file. An illustrative, generic example of such a retrieval instruction executed by the protocol engine 20 under this circumstance is ftpget(directory, filename, filetype) where the parameters directory, filename, and filetype are variables stored in the configuration file 30. Retrieved variables are utilized in the second set of instructions 24 as required to accomplish the task or tasks defined by the ‘synthetic transaction’ in accordance with the specified protocol.

One skilled in the art will appreciate that the specifics regarding the task or tasks accomplished by means of the second set of instructions 22 executed by the protocol engine 20 depend upon the protocol specified for any particular ‘synthetic transaction’. One skilled in the art will be able to generate the second set of instructions 22 necessary to accomplish any such task or tasks specified for any particular ‘synthetic transaction’ in accordance with a specified protocol without undue experimentation.

The configuration file 30 comprises stored information and data (variables) for a particular ‘synthetic transaction’. The configuration file 30 can reside in any primary or secondary storage element, e.g., memory, cache, disk, network storage, network message, accessible to the protocol engine 20 running on the computer C (if the configuration file 30 resides in secondary storage, the protocol engine 20 would preferably move the configuration file 30 to primary storage prior to executing the first set of instructions 22). The variables (data) required to generate a particular ‘synthetic transaction’ in accordance with a specified protocol are stored in the configuration file 30. In addition to storage of the variables required for any particular ‘synthetic transaction’, the configuration file 30 has stored therein: (1) information that defines the behavior of a ‘synthetic user’ implementing the ‘synthetic transaction’; e.g., how many times the each ‘synthetic user’ is to generate the ‘synthetic transaction’, any other actions to be taken by each ‘synthetic user’ in conjunction with the ‘synthetic transaction’ (the terminology “other actions” as used herein means a function or functions performed by the ‘synthetic user’ that is not part of the specified protocol), and (2) information that defines the ‘background client’ implemented by the protocol sleuthing system 10, i.e., how many ‘synthetic users’ will be generated by the protocol engine 20.

For example, with reference to a ‘synthetic transaction’ that is a file transfer request to the network server NSC in accordance with the File Transfer Protocol to retrieve a particular file, e.g., “myfile.html”, as exemplarily illustrated in FIG. 2, the following variables would be stored in the configuration file 30 (# denotes a comment stored in conjunction with the variable):

| | |
|---|---|
| User russ | #Use this as the login name |
| Password secret | #Use this as the password |
| Filetype htm (or html) | #The file is an htm (or html) file |
| Directory / | #Use the default directory |
| Filename myfile.html | #Retrieve this file |

The following illustrative information defining the behavior of the ‘synthetic user’ is stored in the configuration file 30 in the context of such a file transfer request is:

| | |
|---|---|
| Repeat 50 | #Repeat the file transfer |
| | 50 times |
| WaitAfterLoop10 | #Wait 10 seconds after each file transfer to |
| | simulate think time (“other action” part of |
| | the ‘synthetic transaction’) |

The following illustrative information defining the ‘background client’ is stored in the configuration file 30:

| | |
|---|---|
| Clones 1000 | #Create 1000 instances of this synthetic |
| | user. |

The foregoing configuration file 30 information and data defines a ‘background client’ that consists of 1000 ‘synthetic users, each ‘synthetic user’ implementing a ‘synthetic transaction’ 50 times, where each ‘synthetic transaction’ consists of a file transfer request, e.g., for file “myfile.html”, followed by a pause period of 10 seconds.

The protocol engine 20 executes the set of control instructions 26 to implement the ‘background client’. In the first instance, the set of control instructions 26 are executed to create the number of ‘synthetic users’ defined by the ‘background client’. Next, the set of control instructions 26 cause the protocol engine 20 to execute the first set of instructions 22 with respect to each ‘synthetic user’ to establish a client-server relationship between each ‘synthetic user’ and the network server NSC in accordance with the specified protocol (including the retrieval of any variables required to establish the client-server relationship from the configuration file 30). Next, the set of control instructions 26 cause the protocol engine 20 to execute the second set of instructions 24 with respect to each ‘synthetic user’ to implement the behavior of the ‘synthetic users’, i.e., accomplish the task or tasks defined by the ‘synthetic transaction’ in accordance with the specified protocol (including the retrieval of any variables required to accomplish any task or tasks defined by the ‘synthetic transaction’). Next, the set of control instructions 26 cause the protocol engine 20 to repeat the execution of the second set of instructions 24 with respect to each ‘synthetic user’ as defined in the configuration file 30, i.e., to cause each ‘synthetic user’ to implement the number of ‘synthetic transactions’ defined by the configuration file 30 (e.g., 50 ‘synthetic transactions’ in the illustrative ‘synthetic transaction’ described above). Finally, upon completion of the second set of instructions 24, i.e., the number of ‘synthetic transactions’ defined by the configuration file 30 has been completed, the control instructions 26 cause the protocol engine 20 to execute the first set of instructions 24 to terminate the client-server relationship for each ‘synthetic user’. An illustrative example of the implementation of a ‘background client’ consisting of four ‘synthetic users’ is depicted in FIG. 10.

One skilled in the art will be able to generate the second set of instructions 22 necessary to implement a ‘background client’ in accordance with the description herein without undue experimentation.

The protocol engine 20 is further operative to implement the MDR module 40 during the execution of the first and second sets of instructions 22, 24 by the protocol engine 20 operating under the set of control instructions 26. For purposes of facilitating a more complete understanding of this aspect of the protocol sleuthing system 10, the MDR module 40 is depicted as an element separate and distinct from the protocol engine 20. For this embodiment, the protocol engine 20 uses APIs to implement the functionality of the MDR module 40. Alternatively, the functionality of the MDR module 40 could be implemented as another set of instructions stored in the protocol engine 20.

The MDR module 40 is operative to monitor each client-server interaction during establishment of the client-server relationship between each ‘synthetic user’ and the network server NSC and to monitor each client-server interaction between each ‘synthetic user’ and the network server NSC during each ‘synthetic transaction’. The MDR module 40 is further operative to detect any ‘error event’, i.e., error code, that occurs during any of the foregoing client-server interactions. For example, referring to FIG. 8, an exemplary ‘error event’ (as a result of the FTP application of the network server NSC having insufficient memory resources to respond to the ‘synthetic user’ request CR2 to open the application on port abc) that occurs during the establishment of the client-server relationship for any particular ‘synthetic user’ is illustrated. This exemplary ‘error event’ is transmitted to the particular ‘synthetic user’ by the network server NSC as a response SR2 to the ‘synthetic user’ request CR2. The MDR module 40 is operative to detect this ‘error event’ as an anomaly in the context of the expected client-server interactions defined by the specified protocol. Finally, MDR module 40 is operative to provide notification of this anomalous occurrence, i.e., the ‘error event’, as well as an identification of the network server NSC and any relevant context information that can facilitate the isolation/identification of the particular application on the network server NSC responsible for the ‘error event’ to an appropriate application for subsequent processing, e.g., an application stored at the network management station NMS, as exemplarily illustrated in FIG. 9. ‘Error event’ reporting can be effected via the protocol engine 20, as illustrated in FIG. 9, or can be effected directly between the MDR module 40 and the network management station NMS.

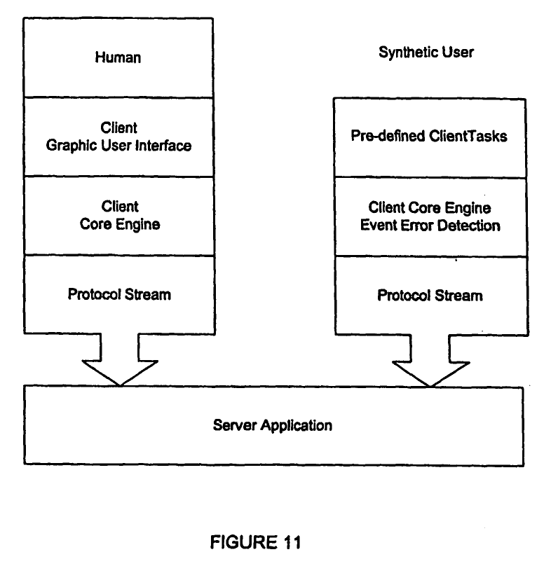

FIG. 11 illustrates the differences between a client-server transaction conducted by an actual user and a client-server transaction implemented by a background client via the protocol sleuthing system and methods. Since there is no human associated with any ‘synthetic user’, there is no need for a user interface, graphic display, or permanent storage of any content provided by a network server application utilizing the protocol sleuthing system 10. The protocol sleuthing system 10 uses substantially less resources in terms of memory and CPU utilization, which allows large numbers of ‘synthetic users’ to be generated via a single client computer.

A variety of modifications and variations of the systems and methods described herein are possible.

We claim:

1. A network load testing system comprising:
an addressable named list means to enable the generation of substantially random and unique network transaction instances simulative of real network traffic patterns,
addressing means operable to address the named list means, and
generating means, operable to communicate with the addressing means, for generating the substantially random and unique network transaction instances simulative of real network traffic patterns.

2. A network load testing system comprising:
means to enable the generation of substantially random and unique attributes to vary a population of synthetic user attributes.

3. The network load testing system of claim 2 wherein:
the synthetic user attributes include any of URLS, hosts, security levels, authentication, ports, and headers.

4. A network load testing system according to claim 1, further comprising:
means to enable the generation of substantially unique but substantially predictable synthetic user attributes for introducing variation into ones of a series of instances.

5. A network load testing system accordingly to claim 1, further comprising:
means for generating network transaction instances in accordance with a distribution that is substantially random but representative of realistic population loads.

6. A network load testing system comprising:
means for generating synthetic transaction instances, simulative of the network load presented by real users, in accordance with a test plan containing multiple population classes, and wherein:
each of the population classes contains attributes that describe the behavior of each instance generated in association with the group.

7. A network load testing system according to claim 6 further comprising:
a network testing resource application for generating, based on the test plan and the attributes contained in the population classes therein, a series of instances and a selected network protocol representative of an actual load.
